(19) United States
(12) Patent Application Publication
(10) Pub. No.: US 2016/0077247 A1
(43) Pub. Date: Mar. 17, 2016

(54) LIGHT-DIFFUSING ELEMENT AND METHOD FOR MANUFACTURING LIGHT-DIFFUSING ELEMENT

(71) Applicant: NITTO DENKO CORPORATION, Osaka (JP)

(72) Inventors: Kozo Nakamura, Ibaraki-shi (JP); Hiroyuki Takemoto, Ibaraki-shi (JP); Seiji Umemoto, Ibaraki-shi (JP)

(73) Assignee: NITTO DENKO CORPORATION, Ibaraki-shi, Osaka (JP)

(21) Appl. No.: 14/783,704

(22) PCT Filed: Apr. 10, 2013
(86) PCT No.: PCT/JP2013/060803

§ 371 Date: Oct. 9, 2015

(51) Int. Cl. G02B 5/02; B05D 5/06; G02B 1/04

(52) U.S. Cl. CPC G02B 5/0242; G02B 5/0263; G02B 5/0278; G02B 1/04; B05D 5/06

(57) ABSTRACT

Provided is a light diffusing element having a high haze value, strong diffusibility, suppressed backscattering, and reduced transmission of straight advancing light. The light diffusing element of the present invention includes: a matrix including a resin component and ultrafine particle components; and light diffusing fine particles dispersed in the matrix, in which a concentration modulation region having a substantially spherical shell shape is formed on an outside of each of the light diffusing fine particles in a vicinity of a surface thereof, a weight concentration of the ultrafine particle components in the concentration modulation region increasing with increasing distance from the each of the light diffusing fine particles, and in which an average center-to-center distance A of the light diffusing fine particles in the light diffusing element, and an average particle diameter B of the light diffusing fine particles in the light diffusing element have a relationship of 0.90<B/A.

### TECHNICAL FIELD

The present invention relates to a light diffusing element and a method of manufacturing a light diffusing element.

### BACKGROUND ART

Alight diffusing element is widely used in illumination covers, screens for projection televisions, surface-emitting apparatus (for example, liquid crystal display apparatus), and the like. In recent years, the light diffusing element has been used for enhancing the display quality of the liquid crystal display apparatus or the like and for improving a viewing angle characteristic, for example. As the light diffusing element, there has been proposed a light diffusing element including a matrix including a resin component and ultrafine particle components, and light diffusing fine particles dispersed in the matrix (see, for example, Patent Literature 1). In this light diffusing element, the matrix and each of the light diffusing fine particles have a refractive index difference, and a region in which a weight concentration of the ultrafine particle components is modulated (concentration modulation region) is formed in the vicinity of a surface of each of the light diffusing fine particles. Thus, light diffusibility is expressed, and backscattering is suppressed. However, while such light diffusing element expresses the effects as described above, there is still room for improvement in that part of incident light is transmitted without being affected by the light diffusing fine particles and the concentration modulation region, thereby advancing straight without being diffused. An excessively large quantity of the straight advancing light adversely affects, for example, the display quality and the viewing angle characteristics of the liquid crystal display apparatus. As means for reducing the straight advancing light, there are given, for example, an increase in thickness of the light diffusing element and an increase in number of fine particles. However, when such means is used, problems arise in that productivity is degraded and that backscattering increases to cause a reduction in contrast in a bright place.

### CITATION LIST

### Patent Literature

[PTL 1] JP 04756099 B2

### SUMMARY OF INVENTION

### Technical Problem

The present invention has been made in order to solve the problems of the related art described above, and an object of the present invention is to provide a light diffusing element having a high haze value, strong diffusibility, suppressed backscattering, and reduced transmission of straight advancing light.

### Solution to Problem

A light diffusing element according to one embodiment of the present invention includes: a matrix including a resin component and ultrafine particle components; and light diffusing fine particles dispersed in the matrix, in which a concentration modulation region having a substantially spherical shell shape is formed on an outside of each of the light diffusing fine particles in a vicinity of a surface thereof, a weight concentration of the ultrafine particle components in the concentration modulation region increasing with increasing distance from the each of the light diffusing fine particles, and in which an average center-to-center distance A of the light diffusing fine particles in the light diffusing element, and an average particle diameter B of the light diffusing fine particles in the light diffusing element have a relationship of 0.90<B/A.

In one embodiment of the present invention, the average center-to-center distance A, the average particle diameter B, and an average distance C between an outermost portion of the concentration modulation region and the surface of the each of the light diffusing fine particles satisfy a relationship of 0.91<(B+2×C)/A.

In one embodiment of the present invention, the average center-to-center distance A, the average particle diameter B, and the average distance C satisfy a relationship of A−(B+2×C)≦0.2 μm.

In one embodiment of the present invention, part of the resin component is contained in the light diffusing fine particles.

According to another embodiment of the present invention, there is provided a method of manufacturing the light diffusing element. The method of manufacturing the light diffusing element includes: a step A of applying an application liquid onto a base material, the application liquid being prepared by dissolving or dispersing a precursor of a resin component of a matrix, ultrafine particle components, and light diffusing fine particles in an organic solvent; a step B of drying the application liquid applied onto the base material; and a step C of polymerizing the precursor, the light diffusing fine particles being swollen before the step C.

In a preferred embodiment, a blending amount of the light diffusing fine particles is 30 parts by weight or less with respect to 100 parts by weight of the matrix.

In a preferred embodiment, a difference between an SP value of the organic solvent and an SP value of the light diffusing fine particles is from 0.2 to 0.8.

In a preferred embodiment, the organic solvent includes a mixed solvent of a first organic solvent and a second organic solvent, and the first organic solvent more easily permeates the light diffusing fine particles than the second organic solvent does, and has higher volatility than the second organic solvent.

### Advantageous Effects of Invention

According to the present invention, the region in which the refractive index is modulated (concentration modulation region in which the concentration of the ultrafine particle components is modulated) is formed in the vicinity of the surface of each of the light diffusing fine particles. Thus, reflection at an interface between the matrix and each of the light diffusing fine particles can be suppressed, and backscattering can be suppressed. Further, the ultrafine particle components are contained in the matrix, and thus a refractive index difference between the matrix and each of the light diffusing fine particles can be increased. By virtue of the synergetic effect of the foregoing, the light diffusing element having a high haze value, strong diffusibility, and suppressed backscattering can be realized. Further, the ratio (B/A) of the average particle diameter B of the light diffusing fine particles in the light diffusing element to the average center-to-center distance A of the light diffusing fine particles is set to a specific value or more, and thus a region in which no light diffusing fine particle is present in plan view can be reduced, and besides, a volume ratio occupied by the concentration modulation region formed in the vicinity of the surface of each of the light diffusing fine particles can be cumulatively increased. Accordingly, a region in which incident light advances straight without being diffused (region in which no light diffusing fine particle is present and no concentration modulation region is formed in plan view) can be greatly reduced. As a result, the transmission of straight advancing light can be greatly suppressed. According to the present invention, the transmission of straight advancing light can be greatly suppressed while backscattering is suppressed without an increase in number of the light diffusing fine particles.

### BRIEF DESCRIPTION OF DRAWINGS

FIG. 1 is a schematic view for illustrating a dispersed state of a resin component of a matrix and light diffusing fine particles in a light diffusing element to be obtained by a manufacturing method according to a preferred embodiment of the present invention.

FIG. 2 is an enlarged schematic view for illustrating the vicinity of a light diffusing fine particle in a light diffusing element of the present invention.

FIG. 3 is a transmission electron microscope image for showing the area ratio of ultrafine particle components in the matrix.

FIG. 4 is a conceptual diagram for illustrating a change in refractive index from the center of the light diffusing fine particle to the matrix in the light diffusing element of the present invention.

FIG. 5(a) is a schematic view for illustrating the state of light diffusing fine particles in plan view of the light diffusing element of the present invention, and FIG. 5(b) is a schematic view for illustrating the state of light diffusing fine particles in plan view of a related-art light diffusing element.

FIG. 6 is a schematic diagram for illustrating a method of calculating a straight advancing light transmittance.

### DESCRIPTION OF EMBODIMENTS

Now, preferred embodiments of the present invention are described with reference to the drawings. However, the present invention is not limited to these specific embodiments.

A. Light Diffusing Element

### A-1. Entire Construction

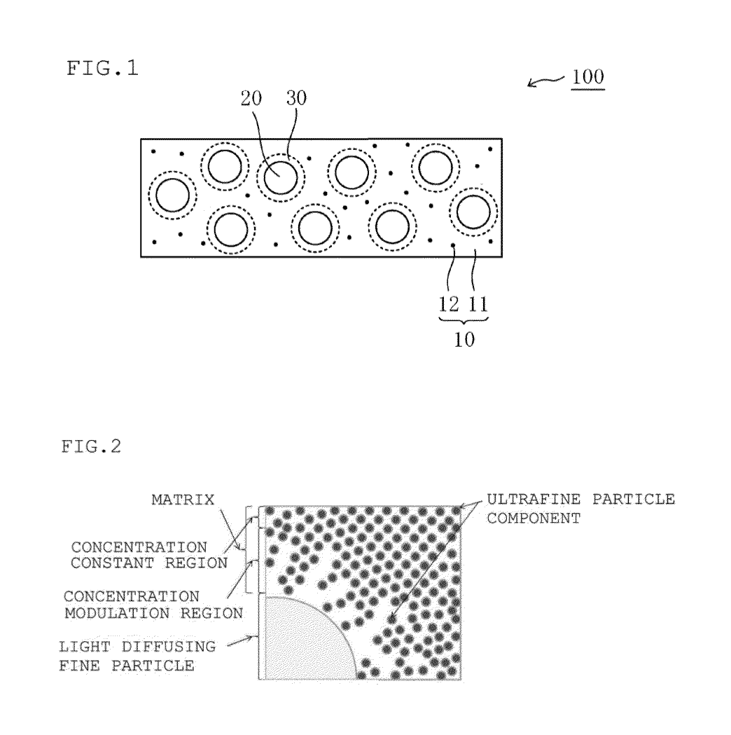

A light diffusing element of the present invention includes a matrix including a resin component and ultrafine particle components, and light diffusing fine particles dispersed in the matrix. The light diffusing element of the present invention expresses a light diffusing function by virtue of a refractive index difference between the matrix and each of the light diffusing fine particles. FIG. 1 is a schematic view for illustrating a dispersed state of a resin component and ultrafine particle components of a matrix, and light diffusing fine particles in a light diffusing element according to a preferred embodiment of the present invention. A light diffusing element 100 of the present invention includes a matrix 10 including a resin component 11 and ultrafine particle components 12, and light diffusing fine particles 20 dispersed in the matrix 10. As illustrated in FIG. 1 and FIG. 2, a concentration modulation region 30 having a substantially spherical shell shape is formed on the outside of each of the light diffusing fine particles 20 in the vicinity of the surface thereof, the weight concentration of the ultrafine particle components in the concentration modulation region increasing with increasing distance from the light diffusing fine particle. Therefore, the matrix has the concentration modulation region 30 in the vicinity of the interface with each of the light diffusing fine particles, and a concentration constant region on the outer side (side away from the light diffusing fine particle) of the concentration modulation region 30. It is preferred that any other portion of the matrix than the concentration modulation region 30 be substantially the concentration constant region. In the concentration modulation region 30, a refractive index substantially continuously changes. The concentration modulation region 30 may have a spherical shell shape having fine unevenness at a boundary. In addition, the innermost portion of the concentration modulation region may be present on the inside of the light diffusing fine particle. The term “vicinity of the surface of each of the light diffusing fine particles” as used herein encompasses the surface of the light diffusing fine particle, the outside of the light diffusing fine particle near the surface, and the inside of the light diffusing fine particle near the surface. In addition, the term “outside of each of the light diffusing fine particles in the vicinity of the surface thereof” encompasses the surface of the light diffusing fine particle and the outside of the light diffusing fine particle near the surface.

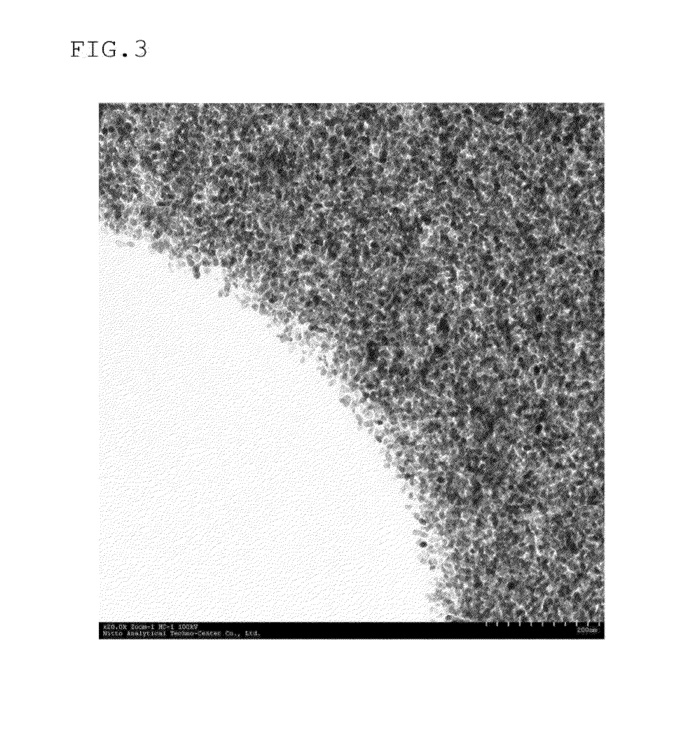

The concentration modulation region 30 is formed by a substantial gradient of the dispersion concentration of the ultrafine particle components 12 in the matrix 10. Specifically, in the concentration modulation region 30, the dispersion concentration (typically specified in terms of weight concentration) of the ultrafine particle components 12 increases (inevitably, the weight concentration of the resin component 11 decreases) with increasing distance from the light diffusing fine particle 20. In other words, in a region of the concentration modulation region 30 closest to the light diffusing fine particle 20, the ultrafine particle components 12 are dispersed at a relatively low concentration, and the concentration of the ultrafine particle components 12 increases with increasing distance from the light diffusing fine particle 20. For example, the area ratio of the ultrafine particle components 12 in the matrix 10 based on a transmission electron microscope (TEM) image is small on a side close to the light diffusing fine particle 20 and large on a side close to the matrix 10, and the area ratio changes while forming a substantial gradient from the light diffusing fine particle side to the matrix side (concentration constant region side). A TEM image for showing a typical dispersed state of the ultrafine particle components is shown in FIG. 3. The term “area ratio of the ultrafine particle components in the matrix based on a transmission electron microscope image” as used herein refers to the ratio of the area occupied by the ultrafine particle components in the matrix in a predetermined range (predetermined area) in a transmission electron microscope image of a cross-section including the diameter of a light diffusing fine particle. The area ratio corresponds to the three-dimensional dispersion concentration (actual dispersion concentration) of the ultrafine particle components. The area ratio of the ultrafine particle components may be determined with any appropriate image analysis software. It should be noted that the area ratio typically corresponds to the average shortest distance between respective particles of the ultrafine particle components. Specifically, the average shortest distance between the respective particles of the ultrafine particle components decreases with increasing distance from the light diffusing fine particle in the concentration modulation region, and becomes constant in the concentration constant region (for example, the average shortest distance is from about 3 nm to 100 nm in a region closest to the light diffusing fine particle, and from 1 nm to 20 nm in the concentration constant region). The average shortest distance may be calculated by binarizing a TEM image of a dispersed state as shown in FIG. 3 and using, for example, the inter-centroid distance method of image analysis software “A-zo-kun” (manufactured by Asahi Kasei Engineering Corporation). As described above, according to the present invention, the concentration modulation region 30 can be formed in the vicinity of the surface of each of the light diffusing fine particles through the utilization of the substantial gradient of the dispersion concentration of the ultrafine particle components 12, and hence the light diffusing element can be manufactured by a much simpler procedure at much lower cost as compared to the case where GRIN fine particles are manufactured by a complicated manufacturing method and the GRIN fine particles are dispersed. Further, when the concentration modulation region is formed through the utilization of the substantial gradient of the dispersion concentration of the ultra fine particle components, the refractive index can be allowed to smoothly change at a boundary between the concentration modulation region 30 and the concentration constant region. Further, through the use of ultrafine particle components each having a refractive index significantly different from those of the resin component and the light diffusing fine particles, the refractive index difference between each of the light diffusing fine particles and the matrix (substantially the concentration constant region) can be increased, and the refractive index gradient of the concentration modulation region can be made steep.

The concentration modulation region may be formed by appropriately selecting materials for forming the resin component and the ultrafine particle components of the matrix, and the light diffusing fine particles, and chemical and thermodynamic characteristics thereof. For example, when the resin component and the light diffusing fine particles are formed of materials of the same type (e.g., organic compounds), and the ultrafine particle components are each formed of a material of a different type from the resin component and the light diffusing fine particles (e.g., an inorganic compound), the concentration modulation region can be satisfactorily formed. Further, for example, it is preferred that the resin component and the light diffusing fine particles be formed of materials having high compatibility with each other among materials of the same type. The thickness and the refractive index gradient of the concentration modulation region may be controlled by adjusting the chemical and thermodynamic characteristics of the resin component and the ultrafine particle components of the matrix, and the light diffusing fine particles. It should be noted that the term “same type” as used herein means that chemical structures and properties are equivalent or similar, and the term “different type” refers to a type other than the same type. Whether or not materials are of the same type varies depending on the way of selecting a standard. For example, based on whether materials are organic or inorganic, organic compounds are compounds of the same type, and an organic compound and an inorganic compound are compounds of different types. Based on a repeating unit of a polymer, for example, an acrylic polymer and an epoxy-based polymer are compounds of different types in spite of the fact that they are both organic compounds. Based on the periodic table, an alkaline metal and a transition metal are elements of different types in spite of the fact that they are both inorganic elements.

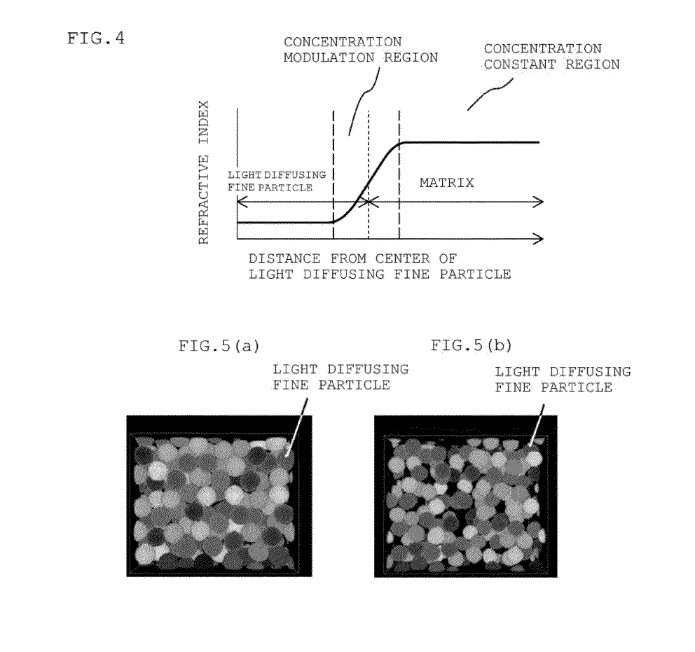

As described above, in the concentration modulation region 30, the refractive index substantially continuously changes. In addition, it is preferred that the refractive index in an outermost portion of the concentration modulation region and the refractive index of the concentration constant region be substantially the same. In other words, in the light diffusing element, the refractive index continuously changes from the concentration modulation region to the concentration constant region, and the refractive index preferably continuously changes from the light diffusing fine particle (more preferably the inside of the light diffusing fine particle near the surface) to the concentration constant region (FIG. 4). The change in refractive index is preferably smooth as illustrated in FIG. 4. That is, the refractive index changes in such a shape that a tangent can be drawn on a refractive index change curve at a boundary between the concentration modulation region and the concentration constant region. In the concentration modulation region, the gradient of the change in refractive index preferably increases with increasing distance from the light diffusing fine particle. According to the light diffusing element of the present invention, a substantially continuous change in refractive index can be realized by appropriately selecting the light diffusing fine particles, and the resin component and the ultrafine particle components of the matrix. As a result, even when the refractive index difference between the matrix 10 (substantially the concentration constant region) and each of the light diffusing fine particles 20 is increased, reflection at an interface between the matrix 10 and each of the light diffusing fine particles 20 can be suppressed, and backscattering can be suppressed. Further, in the concentration constant region, the weight concentration of the ultrafine particle components 12 each having a refractive index significantly different from that of the light diffusing fine particle 20 is relatively high, and hence the refractive index difference between the matrix 10 (substantially the concentration constant region) and the light diffusing fine particle 20 can be increased. As a result, even in a thin film, a high haze (strong diffusibility) can be realized. The phrase “the refractive index substantially continuously changes” as used herein means that the refractive index only needs to substantially continuously change at least from the light diffusing fine particle to the concentration constant region in the concentration modulation region. Therefore, for example, even when a refractive index gap in a predetermined range (e.g., a refractive index difference of 0.05 or less) is present at an interface between the light diffusing fine particle and the concentration modulation region, and/or an interface between the concentration modulation region and the concentration constant region, the gap may be permitted.

The thickness of the concentration modulation region 30 (distance from the innermost portion of the concentration modulation region to the outermost portion of the concentration modulation region) may be constant (that is, the concentration modulation region may spread at the circumference of the light diffusing fine particle in a concentric sphere shape), or the thickness may vary depending on the position of the surface of the light diffusing fine particle (for example, the concentration modulation region may have a shape similar to the contour of konpeito candy).

The concentration modulation region 30 has an average thickness L of preferably from 0.01 μm to 0.6 μm, more preferably from 0.03 μm to 0.5 μm, still more preferably from 0.04 μm to 0.4 μm, particularly preferably from 0.05 μm to 0.4 μm. The average thickness L is an average thickness in the case where the thickness of the concentration modulation region 30 varies depending on the position of the light diffusing fine particle surface, and in the case where the thickness is constant, is the constant thickness.

An average center-to-center distance A of the light diffusing fine particles in the light diffusing element, and an average particle diameter B of the light diffusing fine particles in the light diffusing element have a relationship of 0.90<B/A, preferably a relationship of 0.93≦B/A, more preferably a relationship of 0.95≦B/A, still more preferably a relationship of 0.97≦B/A. The upper limit of (B/A) is preferably 1. When such relationship is satisfied, a region in which no light diffusing fine particle is present in plan view can be reduced, and besides, a volume ratio occupied by the concentration modulation region can be cumulatively increased. Accordingly, a region in which incident light advances straight without being diffused (a region in which no light diffusing fine particle is present and no concentration modulation region is formed in plan view) can be greatly reduced. As a result, light which is transmitted without being affected by the light diffusing fine particles and the concentration modulation region can be reduced, and incident light can be prevented from advancing straight without being diffused. Light which advances straight without being diffused is hereinafter referred to as “straight advancing light”.

The average center-to-center distance A of the light diffusing fine particles in the light diffusing element, the average particle diameter B of the light diffusing fine particles in the light diffusing element, and an average distance C between the outermost portion of the concentration modulation region and the surface of each of the light diffusing fine particles have preferably a relationship of 0.91<(B+2×C)/A, more preferably a relationship of 0.94≦(B+2×C)/A, still more preferably a relationship of 0.96≦(B+2×C)/A, particularly preferably a relationship of 0.98≦(B+2×C)/A. When such relationship is satisfied, light which is transmitted without being affected by the light diffusing fine particles and the concentration modulation region can be reduced, and the transmission of straight advancing light can be prevented.

The average center-to-center distance A of the light diffusing fine particles in the light diffusing element, the average particle diameter B of the light diffusing fine particles in the light diffusing element, and an average distance C between the outermost portion of the concentration modulation region and the surface of each of the light diffusing fine particles have preferably a relationship of A−(B+2×C)≦0.2 μm, more preferably a relationship of A−(B+2×C)≦0.15 μm, still more preferably a relationship of A−(B+2×C)≦0.02 μm, particularly preferably a relationship of A−(B+2×C)≦0 μm. When such relationship is satisfied, light which is transmitted without being affected by the light diffusing fine particles and the concentration modulation region can be reduced, and the transmission of straight advancing light can be prevented. The relational equation “A−(B+2×C)=0” means that the concentration modulation regions of the light diffusing fine particles are substantially brought into contact with each other. In addition, the concentration modulation regions present on the outsides of the light diffusing fine particles may over lap each other. Therefore, A−(B+2×C) may take a negative value. The lower limit of A−(B+2×C) is preferably −2×C.

The light diffusing fine particles having the relationship as described above may be obtained as follows: in the manufacture of the light diffusing element, light diffusing fine particles are sufficiently swollen with an organic solvent and a precursor of a resin component, and then a resin component in a matrix is polymerized. Therefore, the term “average center-to-center distance A of the light diffusing fine particles in the light diffusing element” and the term “average particle diameter B of the light diffusing fine particles in the light diffusing element” mean the average center-to-center distance and the average particle diameter of light diffusing fine particles after swelling, that is, light diffusing fine particles whose particle diameters have been increased as compared to those at the time of loading of the light diffusing fine particles. Details of a method of manufacturing the light diffusing element are described later. In addition, specific measurement methods for the average center-to-center distance A of the light diffusing fine particles in the light diffusing element, the average particle diameter B of the light diffusing fine particles in the light diffusing element, and the average distance C between the outermost portion of the concentration modulation region and the surface of each of the light diffusing fine particles are as described in Examples.

The average center-to-center distance A of the light diffusing fine particles in the light diffusing element is preferably from 1.5 μm to 10 μm, more preferably from 2.5 μm to 8.0 μm, still more preferably from 3.0 μm to 5.0 μm.

The average particle diameter B of the light diffusing fine particles in the light diffusing element is preferably from 1.5 μm to 10 μm, more preferably from 2.5 μm to 8 μm, still more preferably from 3 μm to 8 μm. When the average particle diameter B of the light diffusing fine particles in the light diffusing element falls within such range, a region in which no light diffusing fine particle is present in plan view can be reduced without an increase in number of the light diffusing fine particles, and besides, the volume ratio occupied by the concentration modulation region can be cumulatively increased. Accordingly, the transmission of straight advancing light can be suppressed while backscattering is suppressed. The average particle diameter B of the light diffusing fine particles in the light diffusing element is preferably ½ or less (for example, from ½ to 1/20) of the thickness of the light diffusing element. With the average particle diameter having such ratio to the thickness of the light diffusing element, a plurality of the light diffusing fine particles can be arranged in the thickness direction of the light diffusing element, and hence incident light can be multiply diffused while the light passes through the light diffusing element. As a result, sufficient light diffusibility can be obtained.

The average distance C between the outermost portion of the concentration modulation region and the surface of each of the light diffusing fine particles is preferably from 0.01 μm to 0.5 μm, more preferably from 0.03 μm to 0.5 μm, still more preferably from 0.04 μm to 0.4 μm, particularly preferably from 0.05 μm to 0.4 μm. When the average distance C between the outermost portion of the concentration modulation region and the surface of each of the light diffusing fine particles falls within such range, the transmission of straight advancing light can be suppressed.

FIG. 5(a) is a schematic view for illustrating the state of light diffusing fine particles in plan view of the light diffusing element of the present invention, and FIG. 5(b) is a schematic view for illustrating the state of light diffusing fine particles in plan view of a related-art light diffusing element. In the light diffusing element of the present invention, the light diffusing fine particles can be present in a state of having smaller gaps as illustrated in FIG. 5(a) when the average center-to-center distance A of the light diffusing fine particles in the light diffusing element, the average particle diameter B of the light diffusing fine particles in the light diffusing element, and the average distance C between the outermost portion of the concentration modulation region and the surface of each of the light diffusing fine particles satisfy the above-mentioned relationship. In addition, along with an increase in particle diameter of each of the light diffusing fine particles, the volume ratio occupied by the concentration modulation region to be formed on the outside of each of the light diffusing fine particles in the vicinity of the surface thereof can be cumulatively increased. As a result, a light diffusing element having suppressed transmission of straight advancing light can be obtained. In addition, when the average particle diameter B of the light diffusing fine particles in the light diffusing element falls within the above-mentioned range, the suppression of the transmission of straight advancing light can be realized with a small number of the light diffusing fine particles. As a result, a light diffusing element having excellent light diffusibility by virtue of the suppression of backscattering can be obtained.

The haze value of the light diffusing element is preferably as high as possible. Specifically, the haze value is preferably 70% or more, more preferably from 90% to 99.6%, still more preferably from 92% to 99.6%, yet still more preferably from 95% to 99.6%, even yet still more preferably from 97% to 99.6%, particularly preferably from 98% to 99.6%, most preferably from 98.6% to 99.6%. When the haze value is 70% or more, the light diffusing element can be suitably used as a front light diffusing element in a collimated backlight front diffusing system. It should be noted that the collimated backlight front diffusing system refers to a system in which a front light diffusing element is arranged on a viewer side of an upper polarizing plate, using collimated backlight light (backlight light having a narrow brightness half-width condensed in a constant direction) in a liquid crystal display apparatus.

The diffusion characteristic of the light diffusing element in terms of light diffusion half-angle is preferably from 10° to 150° (one side: 5° to 75°), more preferably from 10° to 100° (one side: 5° to 50°), still more preferably from 30° to 80° (one side: 15° to 40°).

When a parallel light beam is allowed to enter the light diffusing element perpendicularly, the transmittance of light parallel to an incident direction (that is, straight advancing light transmittance) is preferably 2% or less, more preferably 1% or less, still more preferably 0.5% or less, particularly preferably 0.2% or less. It should be noted that the term “straight advancing light transmittance” as used herein refers to the ratio of the light intensity of straight advancing light to the light intensity of total output light (straight advancing light+diffused light).

The thickness of the light diffusing element may be appropriately set depending on purposes and desired diffusing characteristics. Specifically, the thickness of the light diffusing element is preferably from 4 μm to 50 μm, more preferably from 4 μm to 20 μm. According to the present invention, a light diffusing element having the extremely high haze as described above despite such extremely thin thickness can be obtained.

The light diffusing element is suitably used for a liquid crystal display apparatus, and is particularly suitably used for a collimated backlight front diffusing system. The light diffusing element may be providedalone as a film-shapedorplate-shapedmember, or may be provided as a composite member by being bonded to any appropriate base material or polarizing plate. In addition, an antiref lection layer may be laminated on the light diffusing element.

A-2. Matrix

As described above, the matrix 10 preferably includes the resin component 11 and the ultrafine particle components 12. As described above, and as illustrated in FIG. 1 and FIG. 2, the ultrafine particle components 12 are dispersed in the resin component 11 so as to form the concentration modulation region 30 in the vicinity of the surface of each of the light diffusing fine particles 20.

A-2-1. Resin Component

The resin component 11 may be formed of any appropriate material as long as the effects of the present invention are obtained. As described above, the resin component 11 is preferably formed of a compound of the same type as the light diffusing fine particles and of a different type from the ultrafine particle components. With this, the concentration modulation region can be satisfactorily formed in the vicinity of the surface of each of the light diffusing fine particles. The resin component 11 is more preferably formed of a compound having high compatibility among those of the same type as the light diffusing fine particles. With this, a concentration modulation region having a desired refractive index gradient can be formed. More specifically, the energy of the entire system becomes more stable in many cases when each light diffusing fine particle is surrounded only by the resin component locally in the vicinity of the light diffusing fine particle, rather than when the resin component is in a state of being homogeneously dissolved or dispersed with the ultrafine particle components. As a result, the weight concentration of the resin component is higher in the region closest to the light diffusing fine particle than the average weight concentration of the resin component in the entire matrix, and decreases with increasing distance from the light diffusing fine particle. Therefore, the concentration modulation region can be satisfactorily formed in the vicinity of the surface of the light diffusing fine particle. In the present invention, the light diffusing fine particles are swollen in advance by being allowed to contain an organic solvent, and thus affinity between each of the light diffusing fine particles and the resin component can be increased to increase the weight concentration of the resin component in the region closest to the light diffusing fine particle.

The resin component is formed of preferably an organic compound, more preferably an ionizing radiation-curable resin. The ionizing radiation-curable resin is excellent in hardness of an applied film. Examples of the ionizing radiation include UV light, visible light, infrared light, and an electron beam. Of those, UV light is preferred, and thus, the resin component is particularly preferably formed of a UV-curable resin. Examples of the UV-curable resin include resins formed of radically polymerizable monomers and/or oligomers such as an acrylate resin (epoxy acrylate, polyester acrylate, acrylic acrylate, or ether acrylate). The molecular weight of a monomer component (precursor) for forming the acrylate resin is preferably from 200 to 700. Specific examples of the monomer component (precursor) for forming the acrylate resin include pentaerythritol triacrylate (PETA: molecular weight: 298), neopentylglycol diacrylate (NPGDA: molecular weight: 212), dipentaerythritol hexaacrylate (DPHA: molecular weight: 632), dipentaerythritol pentaacrylate (DPPA: molecular weight: 578), and trimethylolpropane triacrylate (TMPTA: molecular weight: 296). An initiator may be added to the precursor as required. Examples of the initiator include UV radical generators (such as Irgacure 907, Irgacure 127, and Irgacure 192 manufactured by BASF Japan Ltd.) and benzoyl peroxide. The resin component may contain another resin component other than the ionizing radiation-curable resin. The another resin component may be an ionizing radiation-curable resin, a thermosetting resin, or a thermoplastic resin. Typical examples of the another resin component include an aliphatic (for example, polyolefin) resin and a urethane-based resin. In the case of using the another resin component, the kind and blending amount thereof are adjusted so that the concentration modulation region is satisfactorily formed.

The refractive indices of the resin component of the matrix and the light diffusing fine particles preferably satisfy the following expression (1).

0<|n_{P}−n_{A}| (1)

In the expression (1), n_{A} represents the refractive index of the resin component of the matrix, and n_{P} represents the refractive index of each of the light diffusing fine particles. |n_{P}−n_{A}| is preferably from 0.01 to 0.10, more preferably from 0.01 to 0.06, particularly preferably from 0.02 to 0.06. When |n_{P}−n_{A}| is less than 0.01, the concentration modulation region may not be formed. When |n_{P}−n_{A}| is more than 0.10, backscattering may increase.

The refractive indices of the resin component of the matrix, the ultrafine particle components, and the light diffusing fine particles preferably satisfy the following expression (2).

0<|n_{P}−n_{A}|<|n_{P}−n_{B}| (2)

In the expression (2), n_{A} and n_{P} are as described above, and n_{B} represents the refractive index of each of the ultrafine particle components. |n_{P}−n_{B}| is preferably from 0.10 to 1.50, more preferably from 0.20 to 0.80. When |n_{P}−n_{B}| is less than 0.10, the haze value of the light diffusing element becomes 90% or less in many cases, and as a result, in the case where the light diffusing element is incorporated into a liquid crystal display apparatus, light from a light source cannot be sufficiently diffused and a viewing angle may be narrowed. When |n_{P}−n_{B}| is more than 1.50, backscattering may increase.

When the refractive indices of the components have the relationships of the expressions (1) and (2), a light diffusing element having suppressed backscattering while maintaining a high haze can be obtained.

The resin component has a refractive index of preferably from 1.40 to 1.60.

The blending amount of the resin component is preferably from 10 parts by weight to 80 parts by weight, more preferably from 20 parts by weight to 80 part by weight, still more preferably from 20 parts by weight to 65 parts by weight, particularly preferably from 45 parts by weight to 65 parts by weight with respect to 100 parts by weight of the matrix.

The resin component may contain another resin component other than the ionizing radiation-curable resin. The another resin component may be an ionizing radiation-curable resin, a thermosetting resin, or a thermoplastic resin. Typical examples of the another resin component include an aliphatic (for example, polyolefin) resin and a urethane-based resin. In the case of using the another resin component, the kind and blending amount thereof are adjusted so that the concentration modulation region is satisfactorily formed.

A-2-2. Ultrafine Particle Components

As described above, the ultrafine particle components 12 are each formed of preferably a compound of a different type from the resin component and the light diffusing fine particles tobe described later, more preferably an inorganic compound. Preferred examples of the inorganic compound include a metal oxide and a metal fluoride. Specific examples of the metal oxide include zirconium oxide (zirconia) (refractive index: 2.19), aluminum oxide (refractive index: 1.56 to 2.62), titanium oxide (refractive index: 2.49 to 2.74), and silicon oxide (refractive index: 1.25 to 1.46). Specific example of the metal fluoride include magnesium fluoride (refractive index: 1.37) and calcium fluoride (refractive index: 1.40 to 1.43). Those metal oxides and metal fluorides absorb less light and each have a refractive index which is difficult to express with an organic compound such as an ionizing radiation-curable resin or a thermoplastic resin. Therefore, the weight concentration of the ultrafine particle components becomes relatively higher with increasing distance from the interface with the light diffusing fine particle, and thus the refractive index can be significantly modulated. When the refractive index difference between each of the light diffusing fine particles and the matrix is set to be large, a high haze (high light diffusibility) can be realized even with a thin film, and the preventive effect on backscattering is large because the concentration modulation region is formed. A particularly preferred inorganic compound is zirconium oxide.

It is preferred that the ultrafine particle components also satisfy the expressions (1) and (2). The refractive index of each of the ultrafine particle components is preferably 1.40 or less or 1.60 or more, more preferably 1.40 or less or from 1.70 to 2.80, particularly preferably 1.40 or less or from 2.00 to 2.80. When the refractive index is more than 1.40 or less than 1.60, the refractive index difference between each of the light diffusing fine particles and the matrix becomes insufficient and sufficient light diffusibility may not be obtained. In addition, when the light diffusing element is used in a liquid crystal display apparatus adopting a collimated backlight front diffusing system, light from a collimated backlight cannot be diffused enough, which may narrow a viewing angle.

The average particle diameter of the ultrafine particle components is preferably from 1 nm to 100 nm, more preferably from 10 nm to 80 nm, still more preferably from 20 nm to 70 nm. As described above, through the use of the ultrafine particle components having an average particle diameter smaller than the wavelength of light, geometric reflection, refraction, and scattering are not caused between each of the ultrafine particle components and the resin component, and a matrix which is optically uniform can be obtained. As a result, a light diffusing element which is optically uniform can be obtained.

It is preferred that the ultrafine particle components have satisfactory dispersibility with the resin component. The term “satisfactory dispersibility” as used herein means that an applied film, which is obtained by applying an application liquid obtained by mixing the resin component, the ultrafine particle components, (a small amount of a UV initiator as required), and the organic solvent, followed by removing the solvent by drying, is transparent.

It is preferred that the ultrafine particle components be subjected to surface modification. By conducting surface modification, the ultrafine particle components can be satisfactorily dispersed in the resin component, and the concentration modulation region can be satisfactorily formed. Any suitable means may be adopted as surface modification means as long as the effects of the present invention are obtained. The surface modification is typically conducted by applying a surface modifier onto the surface of each of the ultrafine particle components to form a surface modifier layer. Preferred specific examples of the surface modifier include coupling agents such as a silane-based coupling agent and a titanate-based coupling agent, and a surfactant such as a fatty acid-based surfactant. Through the use of such surface modifier, the wettability between the resin component and each of the ultrafine particle components is enhanced, the interface between the resin component and each of the ultrafine particle components is stabilized, the ultrafine particle components can be satisfactorily dispersed in the resin component, and the concentration modulation region can be satisfactorily formed.

The blending amount of the ultrafine particle components is preferably from 10 parts by weight to 70 parts by weight, more preferably from 30 parts by weight to 60 parts by weight, still more preferably from 35 parts by weight to 55 parts by weight with respect to 100 parts by weight of the matrix to be formed.

A-3. Light Diffusing Fine Particles

The light diffusing fine particles 20 may each also be formed of any appropriate material as long as the effects of the present invention are obtained. As described above, the light diffusing fine particles 20 are each preferably formed of a compound of the same type as the resin component of the matrix. For example, when the ionizing radiation-curable resin for forming the resin component of the matrix is an acrylate-based resin, it is preferred that each of the light diffusing fine particles be also formed of an acrylate-based resin. More specifically, when the monomer component of the acrylate-based resin for forming the resin component of the matrix is, for example, PETA, NPGDA, DPHA, DPPA, and/or TMPTA as described above, the acrylate-based resin for forming each of the light diffusing fine particles is preferably any of polymethyl methacrylate (PMMA), polymethyl acrylate (PMA), and copolymers thereof, and cross-linked products thereof. As components to be copolymerized with PMMA and PMA, there are given polyurethane, polystyrene (PS), and a melamine resin. The light diffusing fine particles are each particularly preferably formed of PMMA. This is because PMMA has appropriate relationships with the resin component and the ultrafine particle components of the matrix in terms of refractive index and thermodynamic characteristics. Further, the light diffusing fine particles preferably have a cross-linked structure (three-dimensional network structure). Through the adjustment of the density (cross-linking degree) of the cross-linked structure, the degree of freedom of polymer molecules forming the light diffusing fine particles at the surfaces of the fine particles can be controlled, and hence the dispersed state of the ultrafine particle components can be controlled. As a result, a concentration modulation region having a desired refractive index gradient can be formed.

It is preferred that the resin component permeate the light diffusing fine particles and the resin component be contained in the light diffusing fine particles in the light diffusing element. When the resin component permeates the light diffusing fine particles, the concentration modulation region can be formed on the inside of each of the light diffusing fine particles in the vicinity of the surface thereof, and a light diffusing element having a high haze value, strong diffusibility, and suppressed backscattering can be obtained. The permeation range of the precursor in the light diffusing fine particles is preferably 10% or more, more preferably 50% or more, still more preferably from 80% to 100%, particularly preferably from 90% to 100%. When the permeation range falls within such range, the concentration modulation region can be satisfactorily formed to suppress backscattering. The permeation range may be controlled by adjusting, for example, the materials for the resin component and the light diffusing fine particles, the cross-linking density of the light diffusing fine particles, the kind of the organic solvent to be used in the manufacture, and the period of time of standing still and the temperature during the standing still in the manufacture.

The standard deviation of the weight average particle diameter distribution of the light diffusing fine particles in the light diffusing element is preferably 1.0 μm or less, more preferably 0.5 μm or less, particularly preferably 0.1 μm or less. In addition, the diffusing fine particles in the light diffusing element are preferably in a monodispersed state, and for example, have a coefficient of variation in weight average particle diameter distribution ((standard deviation of particle diameter)×100/(average particle diameter)) of preferably 20% or less, more preferably 15% or less. When light diffusing fine particles each having a small particle diameter relative to the weight average particle diameter are present in a large number, the diffusibility may increase too much to satisfactorily suppress backscattering. When light diffusing fine particles each having a large particle diameter relative to the weight average particle diameter are present in a large number, a plurality of the light diffusing fine particles cannot be arranged in the thickness direction of the light diffusing element, and multiple diffusion may not be obtained. As a result, the light diffusibility may become insufficient.

Any appropriate shape may be adopted as the shape of each of the light diffusing fine particles depending on purposes. Specific examples thereof include a spherical shape, a scale-like shape, a plate shape, an elliptic shape, and an amorphous shape. In many cases, spherical fine particles may be used as the light diffusing fine particles.

It is preferred that the light diffusing fine particles also satisfy the expressions (1) and (2). The refractive index of each of the light diffusing fine particles is preferably from 1.30 to 1.70, more preferably from 1.40 to 1.60.

A-4. Method of Manufacturing Light Diffusing Element

A method of manufacturing a light diffusing element according to one embodiment of the present invention includes the steps of: applying an application liquid onto a base material, the application liquid being prepared by dissolving or dispersing a precursor (monomer) of a resin component of a matrix, ultrafine particle components, and light diffusing fine particles in an organic solvent (referred to as step A); drying the application liquid applied onto the base material (referred to as step B); and polymerizing the precursor (referred to as step C).

The light diffusing fine particles are preferably swollen with the organic solvent before the step C. When the light diffusing fine particles are swollen, first, the particle diameters of the light diffusing fine particles can be increased. When the light diffusing fine particles in the light diffusing element have large particle diameters, distances between the light diffusing fine particles can be shortened without an increase in number of the light diffusing fine particles, and hence the transmission of straight advancing light can be suppressed while backscattering is suppressed. Second, when the light diffusing fine particles are swollen, the light diffusing fine particles are covered with the organic solvent and affinity between each of the light diffusing fine particles and the precursor of a resin component can be increased. As a result, at the circumference of each of the light diffusing fine particles, the concentration of the precursor of a resin component becomes high and the dispersion concentration of the ultrafine particle components becomes low. Thus, a thick concentration modulation region can be formed. When the particle diameters are increased and the thick concentration modulation region is formed as described above, there can be obtained a light diffusing element in which the average center-to-center distance A of the light diffusing fine particles in the light diffusing element, the average particle diameter B of the light diffusing fine particles in the light diffusing element, and the average distance C between the outermost portion of the concentration modulation region and the surface of each of the light diffusing fine particles are appropriately adjusted as described above.

In addition, when the light diffusing fine particles are swollen as described above, the precursor of a resin component easily permeates the inside of each of the light diffusing fine particles. Through the permeation of the precursor of a resin component, the light diffusing fine particles are further swollen to have a further increased average particle diameter. In addition, when the precursor of a resin component permeates the inside of each of the light diffusing fine particles, the concentration modulation region can be formed on the inside of each of the light diffusing fine particles in the vicinity of the surface thereof, and a light diffusing element having a high haze value, strong diffusibility, and suppressed backscattering can be obtained.

As a method of swelling the light diffusing fine particles to increase the particle diameters, there are given, for example, a method (method 1) involving using, as the organic solvent, an organic solvent having a solubility parameter (SP value) with a predetermined difference (for example, from 0.2 to 0.8) from the SP value of the light diffusing fine particles, and a method (method 2) involving mixing the light diffusing fine particles in the organic solvent to swell the light diffusing fine particles in advance, and then adding the precursor of a resin component and the ultrafine particle components into the organic solvent to prepare the application liquid in the step A. Those methods may be used in combination.

The swelling degree of the light diffusing fine particles is preferably from 105% to 200%, more preferably from 110% to 200%, still more preferably from 115% to 200%. It should be noted that the term “swelling degree” as used herein refers to the ratio of the average particle diameter of particles in a swollen state (average particle diameter of the light diffusing fine particles in the light diffusing element) to the average particle diameter of particles before swelling. The content ratio of the organic solvent in each of the light diffusing fine particles before the step C is preferably from 10% to 100%, more preferably from 70% to 100%. The term “content ratio of the organic solvent in each of the light diffusing fine particles” as used herein means the content ratio of the organic solvent in each of the light diffusing fine particles with respect to the content of the organic solvent in the case where the organic solvent is contained in the light diffusing fine particle in a saturated state (maximum content).

(Step A)

The precursor of a resin component, the ultrafine particle components, and the light diffusing fine particles are as described in the section A-2-1, the section A-2-2, and the section A-3, respectively. The application liquid is typically a dispersion in which the ultrafine particle components and the light diffusing fine particles are dispersed in the precursor and a volatile solvent. Any appropriate means (e.g., ultrasound treatment, or dispersion treatment with a stirring machine) may be adopted as means for dispersing the ultrafine particle components and the light diffusing fine particles.

In one embodiment, as described above as the (method 2), the application liquid may be prepared by mixing the light diffusing fine particles in the organic solvent to swell the light diffusing fine particles in advance, and then adding the precursor of a resin component and the ultrafine particle components into the organic solvent. The light diffusing fine particles may be swollen by allowing a predetermined period of time to pass after the mixing of the light diffusing fine particles and the organic solvent. For example, the light diffusing fine particles may be swollen by allowing 15 minutes to 90 minutes to pass. The mixed liquid may be prepared by, for example, stirring the light diffusing fine particles in the organic solvent. When the light diffusing fine particles are mixed in the organic solvent to swell the light diffusing fine particles in advance as described above, the application liquid can be subjected to the subsequent step immediately after being prepared, that is, without being left to stand still. Accordingly, the light diffusing fine particles and the ultrafine particle components can be prevented from aggregating, and hence a light diffusing element having excellent smoothness, being free of uneven distribution of the ultrafine particle components, and having less backscattering can be obtained.

Specific examples of the organic solvent include butyl acetate, methyl isobutyl ketone, ethyl acetate, isopropyl acetate, 2-butanone (methyl ethyl ketone), cyclopentanone, toluene, isopropyl alcohol, n-butanol, cyclopentane, and water.

In one embodiment, the organic solvent has a boiling point of preferably 70° C. or more, more preferably 100° C. or more, particularly preferably 110° C. or more, most preferably 120° C. or more. When an organic solvent having relatively low volatility is used, rapid volatilization of the organic solvent during its drying can be prevented, and hence a light diffusing element having excellent smoothness can be obtained.

In another embodiment, a mixed solvent is used as the organic solvent. As the mixed solvent, for example, there is used a solvent obtained by mixing an organic solvent which easily permeates the light diffusing fine particles (first organic solvent), and an organic solvent having low volatility (second organic solvent). It is preferred that the first organic solvent more easily permeate the light diffusing fine particles and have higher volatility than the second organic solvent. It is preferred that the second organic solvent less easily permeate the light diffusing fine particles and have lower volatility than the first organic solvent. The use of such mixed solvent promotes the swelling of the light diffusing fine particles (that is, shortens the period of time required for the manufacturing steps), and prevents rapid volatilization of the organic solvents, with the result that a light diffusing element having excellent smoothness can be obtained. The first organic solvent has a boiling point of preferably 80° C. or less, more preferably from 70° C. to 80° C. The second organic solvent has a boiling point of preferably more than 80° C., more preferably 100° C. or more, still more preferably 110° C. or more, most preferably 120° C. or more. It should be noted that the ease of the permeation of the organic solvent can be compared on the basis of, for example, the swelling degree of the light diffusing fine particles with respect to the organic solvent, and an organic solvent which allows the light diffusing fine particles to be swollen to a higher swelling degree can be said to be an organic solvent which more easily permeates the light diffusing fine particles. In addition, an organic solvent having a solubility parameter (SP value) close to the SP value of the light diffusing fine particles tends to easily permeate the light diffusing fine particles. A difference between the SP value of the first organic solvent and the SP value of the light diffusing fine particles is preferably 0.5 or less, more preferably 0.4 or less, still more preferably from 0.1 to 0.4. A difference between the SP value of the second organic solvent and the SP value of the light diffusing fine particles is preferably more than 0.5, more preferably 0.6 or more, still more preferably from 0.7 to 2.0. In addition, an organic solvent having a low molecular weight tends to easily permeate the light diffusing fine particles. The first organic solvent has a molecular weight of preferably 80 or less, more preferably 75 or less, still more preferably from 50 to 75. The second organic solvent has a molecular weight of preferably more than 80, more preferably 100 or more, still more preferably from 110 to 140.

As the organic solvent, as described above as the (method 1), there may be used an organic solvent having a solubility parameter (SP value) with a predetermined difference from the SP value of the light diffusing fine particles. The absolute value of the difference between the SP value of the organic solvent and the SP value of the light diffusing fine particles is preferably from 0.2 to 0.8, more preferably from 0.2 to 0.7. When the difference between the SP value of the organic solvent and the SP value of the light diffusing fine particles is small (less than 0.2), the dissolution of the light diffusing fine particles may progress with time so much as to cause their aggregation and/or to decrease their particle diameters. When the difference between the SP value of the organic solvent and the SP value of the light diffusing fine particles is large (more than 0.8), the precursor of a resin component may not sufficiently permeate the light diffusing fine particles. On the other hand, when the absolute value of the difference between the SP value of the organic solvent and the SP value of the light diffusing fine particles falls within the above-mentioned range, the dissolution of the light diffusing fine particles can be suppressed to gradually swell the light diffusing fine particles. As a result, light diffusing fine particles having a high swelling degree and large particle diameters can be obtained, and a thick concentration modulation region can be formed. The SP value of the organic solvent is preferably from 8.4 to 9.0, more preferably from 8.5 to 8.7. Specific examples of the organic solvent having such SP value include butyl acetate (SP value: 8.7), methyl isobutyl ketone (SP value: 8.6), and a mixed solvent of any of these solvents and an appropriate other solvent (e.g., methyl ethyl ketone). When the organic solvent having such SP value is used, in the case where the resin for forming each of the light diffusing fine particles is PMMA (SP value: 9.2), light diffusing fine particles having a high swelling degree and having large particle diameters can be obtained, and a thick concentration modulation region can be formed.

The application liquid may further contain any appropriate additive depending on purposes. For example, in order to satisfactorily disperse the ultrafine particle components, a dispersant may be suitably used. Other specific examples of the additive include a UV absorbing agent, a leveling agent, and an antifoaming agent.

The blending amount of the precursor of a resin component in the application liquid is as described in the section A-2-1, and the blending amount of the ultrafine particle components is as described in the section A-2-2. The upper limit of the blending amount of the light diffusing fine particles is preferably 30 parts by weight, more preferably 25 parts by weight, still more preferably 20 parts by weight with respect to 100 parts by weight of the matrix. In the present invention, as described above, the light diffusing fine particles are swollen to increase their particle diameters before the step C (polymerization step), and hence even when the blending amount of the light diffusing fine particles is small, a light diffusing element having a high haze value, strong diffusibility, and reduced transmission of straight advancing light can be obtained. In addition, by virtue of the small blending amount of the light diffusing fine particles, backscattering can be suppressed. The lower limit of the blending amount of the light diffusing fine particles is preferably 5 parts by weight, more preferably 10 parts by weight, still more preferably 15 parts by weight with respect to 100 parts by weight of the matrix.

The solid content of the application liquid may be adjusted so as to be preferably from about 10 wt % to 70 wt %. With such solid content, an application liquid having a viscosity which allows easy application can be obtained.

Any appropriate film may be adopted as the base material as long as the effects of the present invention are obtained. Specific examples thereof include a triacetyl cellulose (TAC) film, a polyethylene terephthalate (PET) film, a polypropylene (PP) film, a nylon film, an acrylic film, and a lactone-modified acrylic film. The base material may be subjected to surface modification such as easy adhesion treatment, or may contain an additive such as a lubricant, an antistat, or a UV absorber, as required.

Any appropriate method using a coater may be adopted as a method of applying the application liquid onto the base material. Specific examples of the coater include a bar coater, a reverse coater, a kiss coater, a gravure coater, a die coater, and a comma coater.

(Step B)

Any appropriate method may be adopted as a method of drying the application liquid. Specific examples thereof include natural drying, drying by heating, and drying under reduced pressure. Of those, drying by heating is preferred. The heating is performed at a temperature of, for example, from 60° C. to 150° C., and the heating is performed for a period of time of, for example, from 30 seconds to 5 minutes.

(Step C)

Any appropriate method may be adopted as the polymerization method depending on the kind of the resin component (thus, the precursor thereof). For example, in the case where the resin component is an ionizing radiation-curable resin, the precursor is polymerized by irradiation with ionizing radiation. In the case of using UV light as the ionizing radiation, the integrated light quantity is preferably from 50 mJ/cm² to 100 mJ/cm², more preferably from 200 mJ/cm² to 400 mJ/cm². The transmittance of the ionizing radiation with respect to the light diffusing fine particles is preferably 70% or more, more preferably 80% or more. In addition, for example, in the case where the resin component is a thermosetting resin, the precursor is polymerized by heating. The heating temperature and the heating time may be appropriately set depending on the kind of the resin component. It is preferred that the polymerization be conducted by irradiation with ionizing radiation. The irradiation with ionizing radiation can cure an applied film while satisfactorily keeping a concentration modulation region, and hence a light diffusing element having a satisfactory diffusion characteristic can be manufactured. Simultaneously with the formation of the matrix by the polymerization of the precursor, a concentration modulation region is formed in the vicinity of the surface of each of the light diffusing fine particles. That is, according to the manufacturing method of the present invention, the precursor permeating the inside of each of the light diffusing fine particles and the precursor not permeating the light diffusing fine particles can be simultaneously polymerized to form the concentration modulation region in the vicinity of the surface of the light diffusing fine particles and to simultaneously form the matrix.

The polymerization step (step C) may be performed before the drying step (step B), or may be performed after the step B. The drying step (step B) is preferably performed before the polymerization step (step C). This is because the heating can promote the permeation of the precursor of a resin component into the light diffusing fine particles.

Needless to say, the method of manufacturing a light diffusing element according to this embodiment may include, in addition to the step A to the step C, any appropriate step, treatment, and/or operation at any appropriate time point. The kind of such step or the like and the time point at which such step or the like is performed may be appropriately set depending on purposes. For example, in the step A, when the (method 2) is not adopted, that is, when the components are simultaneously mixed, the application liquid may be left to stand still for a predetermined period of time before being applied. When the application liquid is left to stand still for a predetermined period of time, the precursor of a resin component can be allowed to sufficiently permeate the light diffusing fine particles. The period of time of the standing still is preferably from 1 hour to 48 hours, more preferably from 2 hours to 40 hours, still more preferably from 3 hours to 35 hours, particularly preferably from 4 hours to 30 hours.

Thus, the light diffusing element as described in the section A-1 to the section A-3 is formed on the base material.

Now, the present invention is specifically described by way of Examples. However, the present invention is not limited by these Examples. Evaluation methods in Examples are as described below. In addition, unless otherwise stated, “part(s)” and “%” in Examples are by weight.

(1) Thickness of Light Diffusing Element

The total thickness of a base material and a light diffusing element was measured with a microgauge-type thickness meter (manufactured by Mitutoyo Corporation), and the thickness of the base material was subtracted from the total thickness to calculate the thickness of the light diffusing element.

(2) Average Center-to-center Distance A and Average Particle Diameter B of Light Diffusing Fine Particles in Light Diffusing Element, and Average Distance C between Outermost Portion of Concentration Modulation Region and Surface of Each of Light Diffusing Fine Particles

A two-dimensional image and a three-dimensional image were observed using a transmission electron microscope (TEM) (manufactured by Hitachi, Ltd., trade name: “H-7650”, accelerating voltage: 100 kV). With regard to the two-dimensional image, a laminate of a light diffusing element and a base material obtained in each of Examples and Comparative Examples was sliced so as to have a thickness of 0.1 μm with a microtome while being cooled with liquid nitrogen to prepare a measurement sample, and the state of a fine particle in the light diffusing element portion of the measurement sample and the state of an interface between the fine particle and a matrix were observed. With regard to the three-dimensional image, gold particles each having a diameter of 5 nm were caused to adhere as markers for photographing position adjustment to the measurement sample obtained in the foregoing, and continuous inclined TEM images (121 images) were taken over the range of from −60° to 60° at intervals of 1°. The 121 TEM images were subjected to position adjustment by a fiducial marker method to reconstruct the three-dimensional image. IMOD 3.9.3 1 was used as reconstruction software and Amira available from Mercuury Computer Systems was used as display software. An interface (actual interface) between a light diffusing fine particle and the matrix was sampled from the three-dimensional reconstructed image thus obtained, and the center-to-center distance a and the particle diameter b of the light diffusing fine particles in the light diffusing element were measured. In addition, the actual interface was subjected to fitting with an approximate curve, and the average height of protruded portions each protruding from the approximate curve in the actual interface by 20 nm or more was measured and adopted as a distance c between the outermost portion of a concentration modulation region and the surface of a light diffusing fine particle. The measurement was performed at five randomly selected sites, and the respective averages of a, b, and c were adopted as the average center-to-center distance A and the average particle diameter B of the light diffusing fine particles in the light diffusing element, and the average distance C between the outermost portion of the concentration modulation region and the surface of each of the light diffusing fine particles. It should be noted that the following equation was used for the approximate curve in the fitting.

z=ax²+by²+cxy+dx+ey+f

(3) Permeation Range of Precursor

Ten light diffusing fine particles were randomly selected from a TEM photograph taken by the procedure described in the section (2). For each of the selected light diffusing fine particles, the particle diameter of the light diffusing fine particle and the particle diameter of a portion of the light diffusing fine particle which was not permeated by a precursor (non-permeation portion) were measured, and a permeation range was calculated by the following equation. An average for the ten light diffusing fine particles was adopted as a permeation range.

(Permeation range)={1−(particle diameter of non-permeation portion/particle diameter of light diffusing fine particle)}×100(%)

(4) Haze Value

Measurement was performed with a haze meter (manufactured by Murakami Color Research Laboratory Co., Ltd., trade name: “HN-150”) in accordance with a method specified in JIS 7136.

(5) Backscattering Ratio

A laminate of a light diffusing element and a base material obtained in each of Examples and Comparative Examples was bonded onto a black acrylic plate (manufactured by Sumitomo Chemical Co., Ltd., trade name: “SUMIPEX” (trademark), thickness: 2 mm) through intermediation of a transparent pressure-sensitive adhesive to prepare a measurement sample. The integrated reflectance of the measurement sample was measured with a spectrophotometer (manufactured by Hitachi Ltd., trade name: “U4100”). On the other hand, a laminate of a base material and a transparent applied layer was produced as a control sample, using an application liquid in which fine particles were removed from the above-mentioned application liquid for a light diffusing element and the integrated reflectance (i.e., surface reflectance) thereof was measured in the same way as described above. The integrated reflectance (surface reflectance) of the control sample was subtracted from the integrated reflectance of the measurement sample to calculate a backscattering ratio of the light diffusing element.

(6) Straight Advancing Light Transmittance

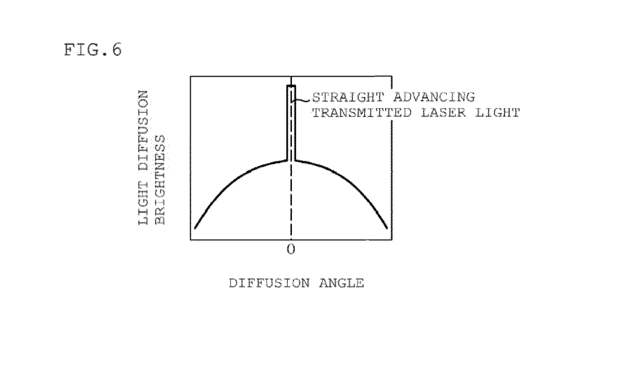

Laser light was applied to a light diffusing element from its front surface, and the diffusion brightness of diffused light at a diffusion angle was measured every 1° with a goniophotometer. The ratio of the light intensity of straight advancing transmitted light to the light intensity of total output light (incident light-reflected light=incident light×0.9) as illustrated in FIG. 6 obtained from the measurement results was adopted as a straight advancing light transmittance.

### Example 1

15 Parts of polymethyl methacrylate (PMMA) fine particles (manufactured by Sekisui Plastics Co., Ltd., trade name: “XX131AA”, average particle diameter: 2.5 μm, refractive index: 1.49) serving as light diffusing fine particles, and 15 parts of a mixed solvent of butyl acetate and MEK (weight ratio 50/50) serving as an organic solvent were mixed and stirred for 60 minutes to prepare a mixed liquid.

Next, to the resultant mixed liquid, 100 parts of a hard coat resin (manufactured by JSR Corporation, trade name: “OPSTAR KZ6661” (containing MEK/MIBK)) containing 62% of zirconia nanoparticles (average particle diameter: 60 nm, refractive index: 2.19) serving as ultrafine particle components, 11 parts of a 50% butyl acetate solution of pentaerythritol triacrylate (manufactured by Osaka Organic Chemical Industry Ltd., trade name: “Viscoat #300”, refractive index: 1.52, molecular weight: 298) serving as a precursor of a resin component, 0.5 part of a photopolymerization initiator (manufactured by Ciba Specialty Chemicals, trade name: “Irgacure 907”), and 0.5 part of a leveling agent (manufactured by DIC Corporation, trade name: “GRANDIC PC 4100”) were added, and the mixture was stirred using a disper for 15 minutes to prepare an application liquid.

The application liquid was applied onto a TAC film (manufactured by Fujifilm Corporation, trade name: “FUJITAC”) using a bar coater and heated at 60° C. for 1 minute, followed by irradiation with UV light having an integrated light quantity of 300 mJ. Thus, a light diffusing element having a thickness of 10 μm was obtained. The obtained light diffusing element was subjected to the evaluations (2) to (6). The results are shown in Table 1.

### Example 2

A light diffusing element was produced in the same manner as in Example 1 except that 15 parts of polymethyl methacrylate (PMMA) fine particles (manufactured by Sekisui Plastics Co., Ltd., trade name: “XX131AA”, average particle diameter: 2.5 μm, refractive index: 1.49) serving as light diffusing fine particles, and 15 parts of a mixed solvent of butyl acetate and MEK (weight ratio: 50/50) serving as an organic solvent were mixed and stirred for 45 minutes to prepare a mixed liquid. The obtained light diffusing element was subjected to the evaluations (2) to (6). The results are shown in Table 1.

### Example 3

To 100 parts of a hard coat resin (manufactured by JSR Corporation, trade name: “OPSTAR KZ6661” (containing MEK/MIBK)) containing 62% of zirconia nanoparticles (average particle diameter: 60 nm, refractive index: 2.19) serving as ultrafine particle components, 11 parts of a 50% methyl isobutyl ketone (MIBK) solution of pentaerythritol triacrylate (manufactured by Osaka Organic Chemical Industry Ltd., trade name: “Viscoat #300”, refractive index: 1.52) serving as a precursor of a resin component, 0.5 part of a photopolymerization initiator (manufactured by Ciba Specialty Chemicals, trade name: “Irgacure 907”), 0.5 part of a leveling agent (manufactured by DIC Corporation, trade name: “GRANDIC PC 4100”), and 15 parts of polymethyl methacrylate (PMMA) fine particles (manufactured by Sekisui Plastics Co., Ltd., trade name: “XX131AA”, average particle diameter: 2.5 μm, refractive index: 1.49) serving as light diffusing fine particles were added. The mixture was subjected to ultrasound treatment for 5 minutes to prepare an application liquid having the above-mentioned components homogeneously dispersed therein. The application liquid was left to stand still for 72 hours, and was then applied onto a TAC film (manufactured by Fujifilm Corporation, trade name: “FUJITAC”) using a bar coater and dried at 60° C. for 1 minute, followed by irradiation with UV light having an integrated light quantity of 300 mJ. Thus, a light diffusing element having a thickness of 10 μm was obtained. The obtained light diffusing element was subjectedtothe evaluations (2) to (6). The results are shown in Table 1.

### Comparative Example 1

To 18.2 parts of a hard coat resin (manufactured by JSR Corporation, trade name: “Opster KZ6661” (containing MEK/MIBK)) containing 62% of zirconia nanoparticles (average particle diameter: 60 nm, refractive index: 2.19) serving as ultrafine particle components, 6.8 parts of a 50% methyl ethyl ketone (MEK) solution of pentaerythritol triacrylate (manufactured by Osaka Organic Chemical Industry Ltd., trade name: “Biscoat #300”, refractive index: 1.52) serving as a precursor of a resin component, 0.068 part of a photopolymerization initiator (manufactured by Ciba Specialty Chemicals, trade name: “Irgacure 907”), 0.625 part of a leveling agent (manufactured by DIC Corporation, trade name: “GRANDIC PC 4100”), and 2.5 parts of polymethyl methacrylate (PMMA) fine particles (manufactured by Sekisui Plastics Co., Ltd., trade name: “XX131AA”, average particle diameter: 2.5 μm, refractive index: 1.49) serving as light diffusing fine particles were added. The mixture was subjected to ultrasound treatment for 5 minutes to prepare an application liquid having the above-mentioned components homogeneously dispersed therein. The application liquid was left to stand still for 24 hours, and was then applied onto a TAC film (manufactured by Fujifilm Corporation, trade name: “FUJITAC”) using a bar coater and dried at 60° C. for 1 minute, followed by irradiation with UV light having an integrated light quantity of 300 mJ. Thus, a light diffusing element having a thickness of 10 μm was obtained. The obtained light diffusing element was subjected to the evaluations (2) to (6). The results are shown in Table 1.

### Comparative Example 2

A light diffusing element was obtained in the same manner as in Comparative Example 1 except that the PMMA fine particles serving as light diffusing fine particles were changed to fine particles available under the trade name “Art Pearl J4P” from Negami Chemical Industrial Co., Ltd. (average particle diameter: 2.1 μm, refractive index: 1.49). The obtained light diffusing element was subjected to the evaluations (2) to (6). The results are shown in Table 1.

TABLE 1

| | | | Period | Average | | | | | | | | | |
|---|---|---|---|---|---|---|---|---|---|---|---|---|---|
| | | | of | center- | Average | | | | | | | | Straight |
| | | | time of | to- | particle | | | | A − | | | | advancing |
| | | | standing | center | diam- | Average | | | (B + | Precursor | | Back- | light |
| | Main | | still | distance | eter | distance | | (B + 2 | 2C) | permeation | Haze | scattering | transmittance |
| | solvent | Mixing method | (hours) | A (μm) | B (μm) | C (μm) | B/A | C)/A | (μm) | range (%) | (%) | (%) | (%) |
| Example 1 | Butyl | Sequential | 0 | 3.1 | 3.0 | 0.05 | 0.97 | 1.00 | 0.00 | 100 | 99.1 | 0.29 | 0.4 |
| | acetate/ | | | | | | | | | | | | |
| | MEK | | | | | | | | | | | | |
| Example 2 | Butyl | Sequential | 0 | 3.0 | 2.8 | 0.04 | 0.93 | 0.96 | 0.12 | 80 | 99.0 | 0.26 | 1.2 |
| | acetate/ | | | | | | | | | | | | |
| | MEK | | | | | | | | | | | | |
| Example 3 | MIBK | Simultaneous | 72 | 3.1 | 3.0 | 0.04 | 0.97 | 0.99 | 0.02 | 100 | 98.9 | 0.36 | 0.8 |
| Comparative | MEK | Simultaneous | 24 | 3.0 | 2.7 | 0.02 | 0.90 | 0.91 | 0.26 | 60 | 98.5 | 0.39 | 2.1 |
| Example 1 | | | | | | | | | | | | | |
| Comparative | MEK | Simultaneous | 24 | 2.6 | 2.3 | 0.03 | 0.88 | 0.91 | 0.24 | 82 | 98.5 | 0.45 | 2.6 |
| Example 2 | | | | | | | | | | | | | |

As apparent from Table 1, when the relationship among the average center-to-center distance A of the light diffusing fine particles in the light diffusing element, the average particle diameter B of the light diffusing fine particles in the light diffusing element, and the average distance C between the outermost portion of the concentration modulation region and the surface of each of the light diffusing fine particles is appropriately adjusted, a high-haze light diffusing element having suppressed backscattering and suppressed transmission of straight advancing light can be obtained. The light diffusing element in which the distance between the light diffusing fine particles, and the thickness on the outside of each of the light diffusing fine particles in the vicinity thereof are adjusted as described above can be obtained by, for example, using an organic solvent having an appropriate SP value (Examples 1 to 3), and/or mixing light diffusing fine particles in an organic solvent to swell the light diffusing fine particles and then adding a precursor of a resin component and ultrafine particle components into the organic solvent to prepare an application liquid (Examples 1 and 2).

### INDUSTRIAL APPLICABILITY

The light diffusing element obtained by the manufacturing method of the present invention is suitably used for a viewer-side member for a liquid crystal display apparatus, a backlight member for a liquid crystal display apparatus, or a diffusing member for illumination equipment (e.g., organic EL, LED), and is particularly suitably used as a front diffusing element in a collimated backlight front diffusing system.

### REFERENCE SIGNS LIST

10 matrix
11 resin component
12 ultrafine particle component
20 light diffusing fine particle
30 concentration modulation region
100 light diffusing element

1. A light diffusing element, comprising:
a matrix including a resin component and ultrafine particle components; and
light diffusing fine particles dispersed in the matrix,
wherein a concentration modulation region having a substantially spherical shell shape is formed on an outside of each of the light diffusing fine particles in a vicinity of a surface thereof, a weight concentration of the ultrafine particle components in the concentration modulation region increasing with increasing distance from the each of the light diffusing fine particles, and
wherein an average center-to-center distance A of the light diffusing fine particles in the light diffusing element, and an average particle diameter B of the light diffusing fine particles in the light diffusing element have a relationship of 0.90<B/A.

2. The light diffusing element according to claim 1, wherein the average center-to-center distance A, the average particle diameter B, and an average distance C between an outermost portion of the concentration modulation region and the surface of the each of the light diffusing fine particles satisfy a relationship of 0.91<(B+2×C)/A.

3. The light diffusing element according to claim 1, wherein the average center-to-center distance A, the average particle diameter B, and the average distance C satisfy a relationship of A−(B+2×C)≦0.2 μm.

4. The light diffusing element according to claim 1, wherein part of the resin component is contained in the light diffusing fine particles.

5. A method of manufacturing the light diffusing element of claim 1, comprising:
a step A of applying an application liquid onto a base material, the application liquid being prepared by dissolving or dispersing a precursor of a resin component of a matrix, ultrafine particle components, and light diffusing fine particles in an organic solvent;
a step B of drying the application liquid applied onto the base material; and
a step C of polymerizing the precursor,
the light diffusing fine particles being swollen before the step C.

6. The method of manufacturing the light diffusing element according to claim 5, wherein a blending amount of the light diffusing fine particles is 30 parts by weight or less with respect to 100 parts by weight of the matrix.

7. The method of manufacturing the light diffusing element according to claim 5, wherein a difference between an SP value of the organic solvent and an SP value of the light diffusing fine particles is from 0.2 to 0.8.

8. The method of manufacturing the light diffusing element according to claim 5,
wherein the organic solvent comprises a mixed solvent of a first organic solvent and a second organic solvent, and
wherein the first organic solvent more easily permeates the light diffusing fine particles than the second organic solvent does, and has higher volatility than the second organic solvent.
